(19) United States
(12) Patent Application Publication
(10) Pub. No.: US 2012/0246444 A1
(43) Pub. Date: Sep. 27, 2012

(54) RECONFIGURABLE PROCESSOR, APPARATUS, AND METHOD FOR CONVERTING CODE

(76) Inventors: Tai-Song Jin, Seoul (KR); Dong-Hoon Yoo, Seoul (KR); Min-Wook Ahn, Seoul (KR); Jin-Seok Lee, Seoul (KR)

(21) Appl. No.: 13/362,363

(22) Filed: Jan. 31, 2012

(30) Foreign Application Priority Data
Mar. 25, 2011 (KR) 10-2011-0027032

(51) Int. Cl. G06F 15/80; G06F 9/06

(52) U.S. Cl. 712/15; 712/E09.003

(57) ABSTRACT

Provided is an apparatus and method capable of processing code to which a software pipelining is not applicable, in a CGA mode. The apparatus may include a processing unit that has a very long instruction word (VLIW) mode and a coarse-grained array (CGA) mode, and an adjusting unit configured to detect a target region to which software pipelining is not applicable, in code to be executed by the processing unit. The adjusting unit may selectively map the detected target region to one of the VLIW mode and the CGA mode according to a schedule length of the detected target region.

### CROSS-REFERENCE TO RELATED APPLICATION(S)

This application claims the benefit under 35 U.S.C. §119(a) of Korean Patent Application No. 10-2011-0027032, filed on Mar. 25, 2011, in the Korean Intellectual Property Office, the entire disclosure of which is incorporated herein by reference for all purposes.

### BACKGROUND

1. Field

The following description relates to a reconfigurable processor.

2. Description of the Related Art

In general, a reconfigurable architecture represents an architecture in which a hardware configuration of a computing device may be optimally modified to process a predetermined task.

When a task is designed to be processed only in a hardware manner, even a small change in the task may make it difficult to effectively process the task due to the rigidity of hardware. In addition, if a task is processed only in a software manner, the software may be adjusted to process changes in the task, however, the processing speed is lower than the hardware.

The reconfigurable architecture has advantageous characteristics of hardware and software. In particular, in a digital signal processing field in which the iteration of operations is performed, the reconfigurable architecture is drawing more attention.

An example of the reconfigurable architecture is a coarse-grained array (CGA). The CGA array typically includes a plurality of processing units that may be optimized to process a task by adjusting a connection state between the processing units.

Another example of a reconfigurable architecture is a processor in which a predetermined processing unit of the CGA is used as a very long instruction word (VLIW) machine. This reconfigurable architecture has two execution modes, a CGA mode and a VLIW mode. In the reconfiguration architecture that has the two execution modes, a loop having the iteration of an operation is typically processed in a CGA mode and other operations except for the loop are typically processed in a VLIW mode.

### SUMMARY

A reconfigurable processor including a processing unit comprising a very long instruction word (VLIW) mode and a coarse-grained array (CGA) mode, and an adjusting unit configured to detect a target region that is a region of code to which software pipelining is not applicable, in code to be executed in the processing unit, and selectively map the detected target region to one of the VLIW mode and the CGA mode according to a schedule length of the detected target region.

The adjusting unit may be further configured to compare a first schedule length representing a schedule length of a target region for the VLIW mode with a second schedule length representing a schedule length of a target region for the CGA mode, and map the target region to the CGA mode if the second schedule length is shorter than the first schedule length.

If the second schedule length is shorter than the first schedule length, the adjusting unit may be configured to map the target region to the CGA mode by inserting a CGA call instruction that is used for mode conversion to the CGA mode, before the target region.

The reconfigurable processor may further comprise a mode control unit configured to control a mode conversion of the processing unit such that the processing unit operates in the CGA mode according to the CGA call instruction during execution of the code.

The adjusting unit may be configured to map the target region to the VLIW mode if the second schedule length is longer than the first schedule length.

The schedule length may correspond to a predicted execution time for a target region in the VLIW mode or the CGA mode.

In another aspect, there is provided an apparatus for converting codes for a reconfigurable processor that has a very long instruction word (VLIW) mode and a coarse-grained array (CGA) mode, the apparatus including a detecting unit configured to detect a target region that is a region of code to which software pipelining is not applicable, in a code to be executed, and a mapping unit configured to selectively map the detected target region to one of the VLIW mode and the CGA mode according to a schedule length of the detected target region.

The mapping unit may be further configured to compare a first schedule length representing a schedule length of a target region for the VLIW mode with a second schedule length representing a schedule length of a target region for the CGA mode, and map the target region to the CGA mode if the second schedule length is shorter than the first schedule length.

If the second schedule length is shorter than the first schedule length, the mapping unit may be configured to map the target region to the CGA mode by inserting a CGA call instruction that is used for conversion to the CGA mode, before the target region.

The mapping unit may be configured to map the target region to the VLIW mode if the second schedule length is longer than the first schedule length.

The schedule length may correspond to a predicted execution time of a target region in the VLIW mode or the CGA mode.

In another aspect, there is provided a method for converting codes for a reconfigurable processor that has a very long instruction word (VLIW) mode and a coarse-grained array (CGA) mode, the method including detecting a target region that is a region of code to which software pipelining is not applicable, in a code to be executed, and selectively mapping the detected target region to one of the VLIW mode and the CGA mode according to a schedule length of the detected target region.

The mapping of the detected target region may comprise comparing a first schedule length representing a schedule length of a target region for the VLIW mode with a second schedule length representing a schedule length of a target region for the CGA mode, and mapping the target region to the CGA mode if the second schedule length is shorter than the first schedule length.

The mapping of the target region to the CGA mode may comprise inserting a CGA call instruction that is used for conversion to the CGA mode, before the target region.

The schedule length may correspond to a predicted execution time for a target region in the VLIW mode or the CGA mode.

In another aspect, there is provided a reconfigurable processor including an adjuster configured to classify code to be executed into a software pipeline (SP) region to which software pipelining is applicable and a target region to which software pipelining is not applicable, and to divide the target region into first code to be executed in a first processing mode and second code to be executed in a second processing mode, and a processor configured to process the first code in the first processing mode and to process the second code in the second processing mode.

The adjuster may be configured to predict a first execution time of the target region in the first processing mode and to predict a second execution time in the second processing mode, and to divide the target region into the first code and the second code based on a comparison of the first predicted execution time and the second predicted execution time.

The target region to which software pipelining is not applicable may comprise at least one of a function call, a jump command, and a branch command.

The first processing mode may be a coarse-grained array (CGA) mode and the second processing mode may be a very long instruction word (VLIW) mode.

Other features and aspects may be apparent from the following detailed description, the drawings, and the claims.

### BRIEF DESCRIPTION OF THE DRAWINGS

FIG. 1 is a diagram illustrating an example of a reconfigurable processor.

FIG. 2 is a diagram illustrating an example of an apparatus for converting codes for a reconfigurable processor.

FIG. 3 is a diagram illustrating an example of a program code.

FIG. 4 is a diagram illustrating an example of code mapping.

FIG. 5 is a diagram illustrating an example of the differences between a CGA sp mode and a CGA non-sp mode.

FIG. 6 is a diagram illustrating an example of a CGA non-sp mode mapping.

FIG. 7 is a diagram illustrating an example of a method of converting codes.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

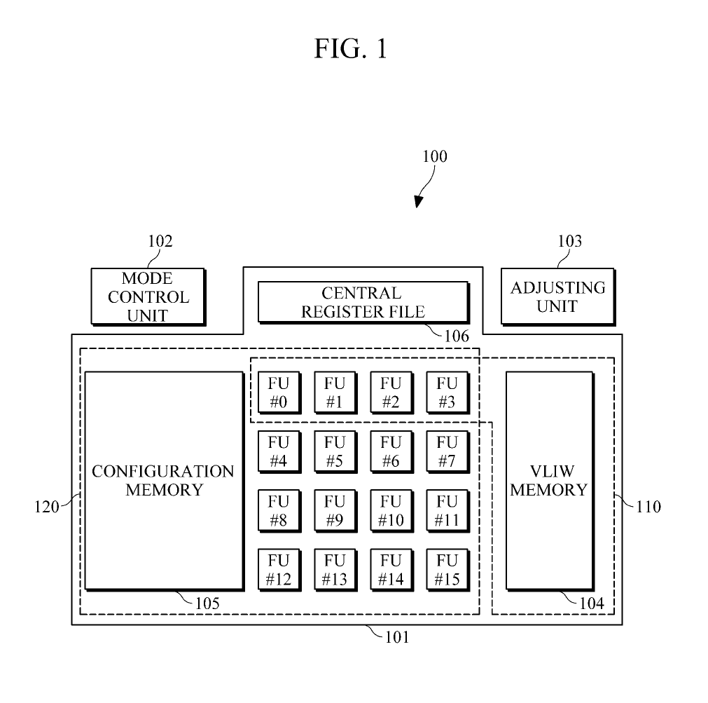

FIG. 1 illustrates an example of a reconfigurable processor. The reconfigurable processor may be included in a terminal device, for example, a smart phone, a tablet, a laptop computer, a personal computer, an MP3 player, a home appliance, a television, a sensor, and the like.

Referring to FIG. 1, a reconfigurable processor 100 includes a processing unit 101, a mode control unit 102, and an adjusting unit 103.

The processing unit 101 may include a plurality of function units such as FU#0 to FU#15. Each function unit FU#0 to FU#15 may independently process a job, a task, an instruction, and the like. For example, while function unit FU#1 processes a first instruction, function unit FU#2 may process a second instruction that does not rely on the first instruction. Each of the function units FU#0 to FU#15 may include a processing element (PE) that performs arithmetic/logic operations and a register file (RF) that temporarily stores the processing result.

In this example, the processing unit 101 has two execution modes. The two execution modes include a very long instruction word (VLIW) mode and a coarse grained array (CGA) mode.

In a VLIW mode, the processing unit 101 may operate based on a VLIW machine 110. In this example, the processing unit 101 may process VLIW instructions using a portion of the function units FU#0 to FU#15, for example, FU#0 to FU#3. As an example, the VLIW instruction may include operations except for a loop operation. The VLIW instruction may be loaded from a VLIW memory 104.

In a CGA mode, the processing unit 101 may operate based on a CGA machine 120. For example, the processing unit 101 may process CGA instructions using each of the function units FU#0 to FU #15. For example, the CGA instruction may include a loop operation. In addition, the CGA instruction may include configuration information that identifies a connection state between function units. The CGA instruction may be loaded from a configuration memory 105.

As an example, the processing unit 101 may perform operations except for a loop operation in the VLIW mode, and may perform a loop operation in the CGA mode. In the case that a loop operation is performed in a CGA mode, the connection state between function units may be optimized for the loop operation, which is to be processed, based on configuration information that is stored in the configuration memory 105.

The mode control unit 102 may control the mode conversion of the processing unit 101. For example, the mode control unit 102 may convert the mode of the processing unit 101 from a VLIW mode to a CGA mode, or from a CGA mode to a VLIW mode, to correspond to a predetermined instruction that is included in code that is to be executed by the processing unit 101. For example, based on an instruction that is to be processed, the mode control unit 102 may switch the mode of the processing unit 101.

A central register file 106 may store context information that is obtained during the mode conversion. For example, live-in data and/or live-out data associated with the mode conversion may be temporarily stored in the central register file 106.

The adjusting unit 103 may analyze code to be executed in the processing unit 101, and may determine an execution mode between a VLIW mode and a CGA mode to process the code based on the result of the analysis.

For example, the adjusting unit 103 may divide an execution code into a part to which software pipelining is applicable and a part to which software pipelining is not applicable. The adjusting unit 103 may map the portion to which software pipelining is applicable to a CGA mode.

In addition, the adjusting unit 103 may classify the part to which software pipelining is not applicable, into a data part and a control part. The data part may represent a part that has a high level of data parallelism in a code, and the control part may represent a part that controls the execution flow of the code. The data part and the control part may be classified according to the schedule length. Examples of criteria for classification between the data part and control part are further described herein.

In addition, the adjusting part 103 may map the data part and the control part to which a software pipelining is not applicable, to a CGA mode and a VLIW mode, respectively. According to this example, the part to which a software pipelining is not applicable may be referred to as a target region. In addition, a CGA mode that has mapped thereto the part to which a software pipelining is applicable, is referred to as a CGA sp mode. A CGA mode that has mapped thereto the data part to which a software pipelining is not applicable, is referred to as a CGA non-sp mode.

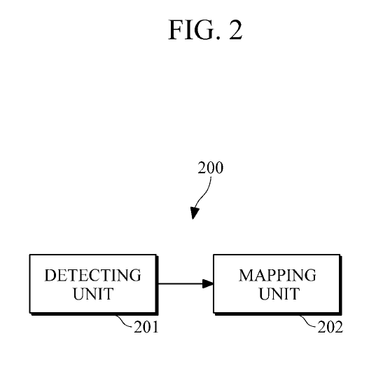

FIG. 2 illustrates an example of an apparatus for converting codes for a reconfigurable processor. The apparatus for converting codes for a reconfigurable processor is an example of the adjusting unit 103 of FIG. 1.

Referring to FIG. 2, apparatus 200 for converting codes may include a detecting unit 201 and a mapping unit 202.

The detecting unit 201 may detect a target region in the entire code. The target region may be defined as code to which software pipelining is not applicable. For example, the detecting unit 201 may detect regions of the entire code, except for a loop region, as a target region.

The mapping unit 202 may selectively map the detected target region to one of a VLIW mode and a CGA mode. For example, the mapping unit 202 may calculate the schedule length of the detected target region, and map the detected target region to one of a VLIW mode and a CGA mode based on the result of calculation.

For this example, the schedule length may correspond to the execution time of the target region in a predetermined mode. In this example, the mapping unit 202 may predict a VLIW execution time that it will take to execute a target region in a VLIW mode, and a CGA execution time that it will take to execute a target region in a CGA mode. In addition, the mapping unit 202 may compare the predicted VLIW execution time with the predicted CGA execution time to determine an execution mode to which a target region is mapped.

For example, the mapping unit 202 may compare a VLIW schedule length that represents a schedule length of a target region for a VLIW mode with a CGA schedule length that represents a schedule length of a target region for a CGA mode.

For example, if the CGA schedule length is shorter than the VLIW schedule length, the mapping unit 202 may classify the target region into a data part, and map the target region to a CGA mode. If the CGA schedule length is longer than the VLIW schedule length, the mapping unit 202 may classify the target region into a control part, and map the target region to a VLIW mode. In mapping a target region to a CGA mode, the mapping unit 202 may insert a CGA call instruction before the target region. The CGA call instruction may be used for mode conversion to the CGA mode, before the target region, thereby mapping the target region to a CGA mode.

In this example, before the target region represents a position of a code in which the execution is about to enter the target region in the sequence of execution. Sometime before, after, and/or while the CGA call instruction is being inserted, the mode control unit 102 (see FIG. 1) may convert the execution mode of the processing unit 101 to a CGA mode, in response to the inserted CGA call instruction.

In addition, the mapping unit 202 may insert a return instruction that is used for mode conversion to a VLIW mode, into a region after the target region. In this example, after the target region represents a position of a code after the target region in the sequence of execution. As an example, the return instruction may be inserted into a section of code that immediately follows the target region.

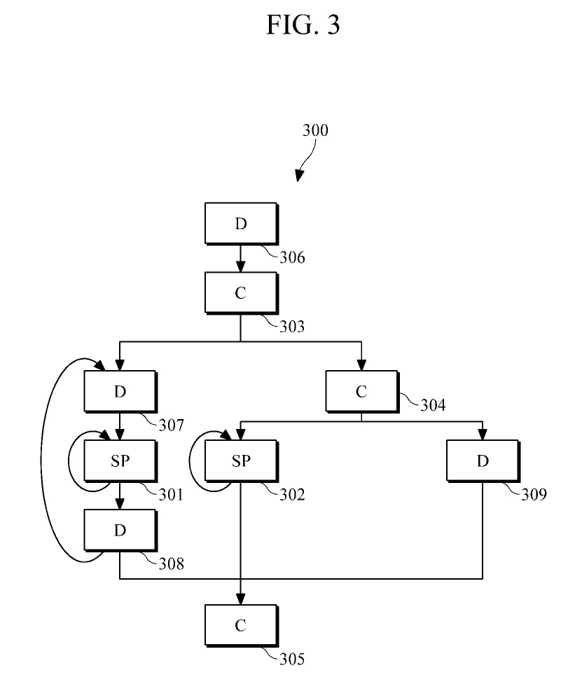

FIG. 3 illustrates an example of program code.

In FIG. 3, each block of program code represents a base block in an execution code.

Referring to FIGS. 2 and 3, the apparatus 200 for converting codes may classify the entire code 300 into a SP region that includes SP blocks 301 and 302 and a target region that includes C blocks and D blocks 303 to 309. In this example, the SP region represents a part to which software pipelining is applicable and the target region represents a part to which software pipelining is not applicable. The part to which a software pipelining is applicable may correspond to an inner most loop that does not have a control operation, for example, a function call, a jump, or a branch. The apparatus 200 for converting codes may analyze the structure or the contents of the code 300 to be executed, and divide the code into a part to which software pipelining is applicable and a part to which software pipelining is not applicable.

In addition, the apparatus 200 for converting codes may divide the target regions 303 to 309 to control parts 303 to 305 (C blocks) and data parts 306 to 309 (D blocks) according to the schedule length. For example, the apparatus 200 may compare a predicted execution time of a target region for a VLIW mode with a predicted execution time of a target region for a CGA mode, and determine whether the target region is a control part or a data part based on the result of comparison. For example, the data part may be a part that has a relatively high level of data parallelism. The apparatus 200 may divide the target regions 303 into first code such as control parts 303 to 305 that are to be processed in VLIW mode and into second code such as data parts 306 to 309 that are to be processed in CGA mode.

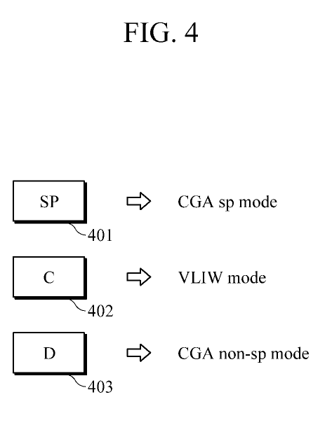

FIG. 4 illustrates an example of code mapping.

Referring to FIGS. 2 and 4, the apparatus 200 for converting codes may map SP block 401 and a D block 403 to CGA modes, and map C block 402 to a VLIW mode. In addition, according to this example, a CGA mode to which the SP block 401 is mapped is referred to as a CGA sp mode and a CGA mode to which the D block 403 is mapped is referred to as a CGA non-sp mode.

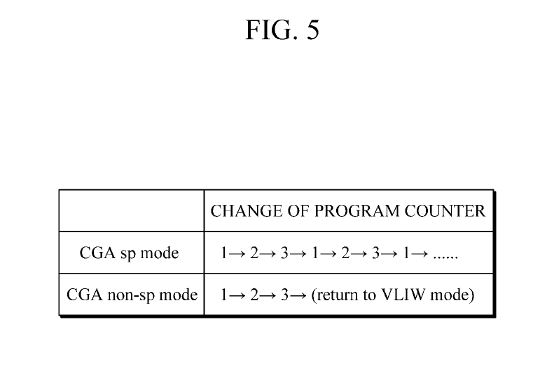

FIG. 5 illustrates an example of the differences between a CGA sp mode and a CGA non-sp mode.

Referring to FIG. 5, in a CGA sp mode, a program counter changes while repeating the sequence of 1, 2 and 3, for example, 1, 2, 3, 1, 2, 3 . . . . For example, in FIG. 1, the program counter that indicates an execution position of a program may repeatedly and sequentially change to correspond to a first position, a second position, and a third position of the configuration memory 105 (see FIG. 1).

In this example, after the program counter has changed in the sequence of 1, 2 and 3 in the CGA non-sp mode, the execution mode returns to a VLIW mode. For example, in FIGS. 1 and 2, the adjusting unit 103 may insert a CGA call instruction before a target region corresponding to the data parts 306 to 309 and insert a return instruction after the target region. The mode control unit 102 may call a CGA mode such that the program counter sequentially indicates a first position, a second position, and a third position of the configuration memory 105 according to the inserted CGA call instruction. In addition, after the program counter indicates the third position of the configuration memory 105, the execution mode of the processing unit 101 is converted to a VLIW mode based on the inserted return instruction and the program counter indicates a predetermined position of the VLIW memory 104.

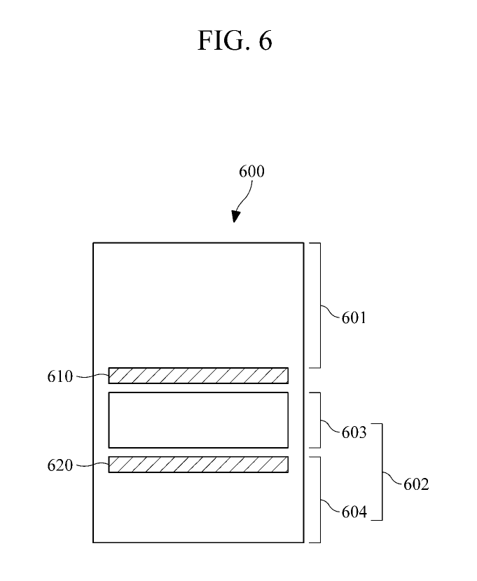

FIG. 6 illustrates an example of a CGA non-sp mode mapping.

Referring to FIGS. 1 and 6, a code 600 to be executed in the processing unit 101 is divided into a part 601 to which software pipelining is applicable and a part 602 to which software pipelining is not applicable. Part 602 is also referred to as a target region. In addition, part 602 to which a software pipelining is not applicable is divided into a data part 603 and a control part 604 based on the schedule length.

For example, the adjusting unit 103 may map the data part 603 of the target region 602 to a CGA non-sp mode. For example, the adjusting unit 103 may insert a CGA call instruction that is used for a mode conversion to a CGA mode, before the data part 603. The adjusting unit 103 may insert a return instruction that is used to terminate a CGA mode and convert to a VLIW mode, after the data part 603.

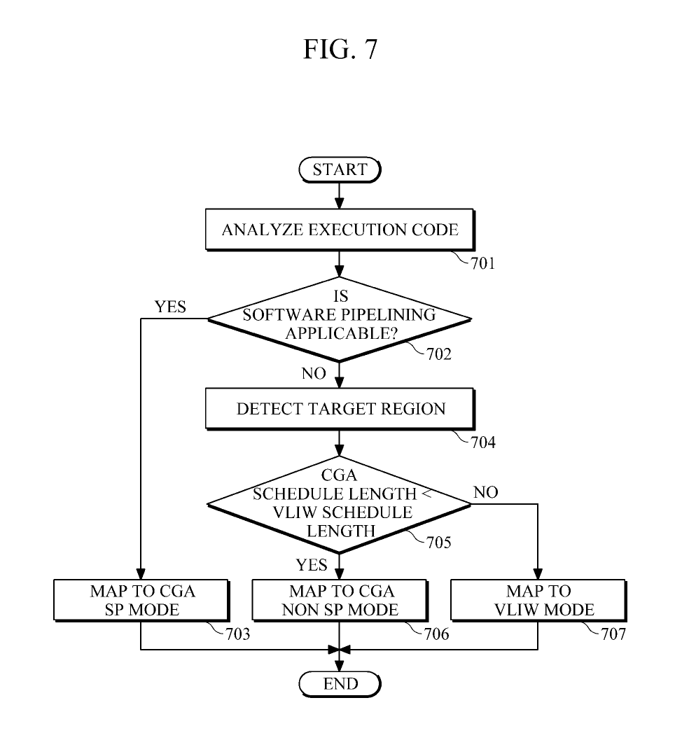

FIG. 7 illustrates an example of a method of converting codes.

Referring to FIGS. 1 and 7, the adjusting unit 103 analyzes an execution code and determines whether a software pipelining is applicable to each part of the execution code (702).

If a software pipelining is applicable to a predetermined region, the adjusting unit 103 maps the region to a CGA sp mode (703). For example, in FIG. 3, the SP blocks 301 and 302 are mapped to a CGA sp mode.

In addition, if a software pipelining is not applicable to a predetermined region, the adjusting unit 103 detects the region as a target region (704), and compares a VLIW schedule length of the detected target region with a CGA schedule length of the detected target region (705).

If the CGA schedule length is shorter than the VLIW schedule length, the adjusting unit 103 maps the target region to a CGA non-sp mode (706). If the CGA schedule length is longer than the VLIW schedule length, the adjusting unit 103 maps the target region to a VLIW mode (707). For example, in FIG. 3, the C blocks 303 to 305 are mapped to a VLIW mode, and the D blocks 306 to 309 are mapped to a CGA non-sp mode.

As described herein, even if software pipelining is not applicable to a predetermined part of a code, the predetermined part may be executed in a CGA. In this manner, a part of code that has a high level of data parallelism may be effectively processed. That is, a predetermined part that has a high level of data parallelism from among parts that are not suitable for software pipelining may be processed through a CGA mode, so that the overall operation speed is increased.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A reconfigurable processor comprising:
a processing unit comprising a very long instruction word (VLIW) mode and a coarse-grained array (CGA) mode; and
an adjusting unit configured to detect a target region that is a region of code to which software pipelining is not applicable, in code to be executed in the processing unit, and selectively map the detected target region to one of the VLIW mode and the CGA mode according to a schedule length of the detected target region.

2. The reconfigurable processor of claim 1, wherein the adjusting unit is further configured to compare a first schedule length representing a schedule length of a target region for the VLIW mode with a second schedule length representing a schedule length of a target region for the CGA mode, and map the target region to the CGA mode if the second schedule length is shorter than the first schedule length.

3. The reconfigurable processor of claim 2, wherein, if the second schedule length is shorter than the first schedule length, the adjusting unit is configured to map the target region to the CGA mode by inserting a CGA call instruction that is used for mode conversion to the CGA mode, before the target region.

4. The reconfigurable processor of claim 3, further comprising a mode control unit configured to control a mode conversion of the processing unit such that the processing unit operates in the CGA mode according to the CGA call instruction during execution of the code.

5. The reconfigurable processor of claim 2, wherein the adjusting unit is configured to map the target region to the VLIW mode if the second schedule length is longer than the first schedule length.

6. The reconfigurable processor of claim 1, wherein the schedule length corresponds to a predicted execution time for a target region in the VLIW mode or the CGA mode.

7. An apparatus for converting codes for a reconfigurable processor that has a very long instruction word (VLIW) mode and a coarse-grained array (CGA) mode, the apparatus comprising:
a detecting unit configured to detect a target region that is a region of code to which software pipelining is not applicable, in a code to be executed; and
a mapping unit configured to selectively map the detected target region to one of the VLIW mode and the CGA mode according to a schedule length of the detected target region.

8. The apparatus of claim 7, wherein the mapping unit is further configured to compare a first schedule length representing a schedule length of a target region for the VLIW mode with a second schedule length representing a schedule length of a target region for the CGA mode, and map the target region to the CGA mode if the second schedule length is shorter than the first schedule length.

9. The apparatus of claim 8, wherein, if the second schedule length is shorter than the first schedule length, the mapping unit is configured to map the target region to the CGA mode by inserting a CGA call instruction that is used for conversion to the CGA mode, before the target region.

10. The reconfigurable processor of claim 8, wherein the mapping unit is configured to map the target region to the VLIW mode if the second schedule length is longer than the first schedule length.

11. The reconfigurable processor of claim 7, wherein the schedule length corresponds to a predicted execution time of a target region in the VLIW mode or the CGA mode.

12. A method for converting codes for a reconfigurable processor that has a very long instruction word (VLIW) mode and a coarse-grained array (CGA) mode, the method comprising:
is detecting a target region that is a region of code to which software pipelining is not applicable, in a code to be executed; and
selectively mapping the detected target region to one of the VLIW mode and the CGA mode according to a schedule length of the detected target region.

13. The method of claim 12, wherein the mapping of the detected target region comprises:
comparing a first schedule length representing a schedule length of a target region for the VLIW mode with a second schedule length representing a schedule length of a target region for the CGA mode; and
mapping the target region to the CGA mode if the second schedule length is shorter than the first schedule length.

14. The method of claim 13, wherein the mapping of the target region to the CGA mode comprises inserting a CGA call instruction that is used for conversion to the CGA mode, before the target region.

15. The method of claim 12, wherein the schedule length corresponds to a predicted execution time for a target region in the VLIW mode or the CGA mode.

16. A reconfigurable processor comprising:
an adjuster configured to classify code to be executed into a software pipeline (SP) region to which software pipelining is applicable and a target region to which software pipelining is not applicable, and to divide the target region into first code to be executed in a first processing mode and second code to be executed in a second processing mode; and
a processor configured to process the first code in the first processing mode and to process the second code in the second processing mode.

17. The reconfigurable processor of claim 16, wherein adjuster is configured to predict a first execution time of the target region in the first processing mode and to predict a second execution time in the second processing mode, and to divide the target region into the first code and the second code based on a comparison of the first predicted execution time and the second predicted execution time.

18. The reconfigurable processor of claim 16, wherein the target region to which software pipelining is not applicable comprises at least one of a function call, a jump command, and a branch command.

19. The reconfigurable processor of claim 16, wherein the first processing mode is a coarse-grained array (CGA) mode and the second processing mode is a very long instruction word (VLIW) mode.
